(19) United States
(12) Patent Application Publication
(10) Pub. No.: US 2007/0071652 A1
(43) Pub. Date: Mar. 29, 2007

(54) Method and apparatus for manipulating and measuring solids

(76) Inventors: Jean-Pei Cherng, Sudbury, MA (US); Michael Cima, Winchester, MA (US); Javier Gonzalez-Zugasti, North Billerica, MA (US); Nathan Kane, Arlington, MA (US); Anthony Lemmo, Sudbury, MA (US); Christopher Moore, Cambridge, MA (US); Alex Slocum, Bow, NH (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/533,619

(22) PCT Filed: Nov. 3, 2003
(86) PCT No.: PCT/US03/34945

§ 371 Date: Aug. 23, 2006

(51) Int. Cl. B01L 3/02

(52) U.S. Cl. 422/100

(57) ABSTRACT

Methods of manipulating (e.g., obtaining, separating, and moving) and weighing solids, particularly dry powders, are disclosed. Also disclosed are devices that can be used to accurately and manipulate solids such as, but not limited to, dielectrophoresis-based devices, coring devices, and micromechanical tweezers.

### CROSS REFERENCE TO RELATED APPLICATIONS

This application claims priority under 35 USC 119(e) to U.S. Provisional Application No. 60/423,377, filed Nov. 4, 2002, U.S. Provisional Application No. 60/424,001, filed Nov. 6, 2002, U.S. Provisional Application No. 60/430,089, filed Dec. 2, 2002, U.S. Provisional Application No. 60/449,554, filed Feb. 24, 2003 and U.S. Provisional Application No. 60/450,285, filed Feb. 27, 2003, all of which are incorporated herein by reference in their entireties.

### TECHNICAL FIELD OF THE INVENTION

This invention relates to methods and apparatuses for manipulating solids. Specific embodiments of the invention are particularly suited for the automated transfer and weighing of small quantities of solid particles.

### BACKGROUND OF THE INVENTION

Methods of accurately weighing and transferring small amounts of solids are becoming more important as techniques are developed to test and otherwise use small amounts of compounds. For example, methods of rapidly screening the chemical and physical characteristics of compounds can benefit from automated methods of transferring small amounts of solids. See, e.g., International Publication WO01/51919 of M. Cima et al., published on Jul. 19, 2001. Combinatorial chemistry and pharmaceutical manufacturing can also benefit from methods of accurately weighing and transferring small amounts of solids.

A variety of techniques have been developed for manipulating particles suspended in liquids. For example, dielectrophoresis has been used to collect and separate biological particles (e.g., cells, bacteria, and DNA) in aqueous media, and methods of quantifying such particles have been developed. Some methods utilize optical detection, wherein collected particles are counted as they flow through an imaging frame. See, e.g., A. P. Brown et al., “Evaluation of a Dielectrophoretic Bacterial Counting Technique,” Biosensors & Bioelectronics, 14:341-351 (1999); http://www.cell-analysis.com. Others use fluorescence labeling and photomicroscopy, although such methods typically require contamination of the particles being measured. See, e.g., N. G. Green and H. Morgan, “Dielectrophoretic Separation of Nano-particles,” J. Phys. D: Appl. Phys. 30:L41-44 (1997). Still other methods correlate the change in electrical impedance between the dielectrophoresis electrodes with the number of particles between them. See, e.g., J. Suehiro et al., “Qualitative Estimation of Biological Cell Concentration Suspended in Aqueous Medium by Using Dielectrophoretic Impedance Measurement Method,” J. Phys. D: App. Phys. 32:2814-2820 (1999); D. W. Allsopp et al., “Impedance Technique for Measuring Dielectrophoretic Collection of Microbiological Particles,” J. Phys. D: Appl. Phys. 32:1066-1074 (1999). Unfortunately, none of these methods are suited for determining the mass or weight of a solid.

Recently, dielectrophoresis has been used to manipulate dry powders on the micron scale. See, e.g., M. M. Tupper, M. E. Chopinaud, T. Ogawa, M. J. Cima, “Electrostatic Dispensing of Dry Dielectric Materials,” Proceedings of the Materials Research Society Symposium (2001). But while the method promises to be effective for the transfer of solids, it does not solve the problem of weighing and/or controlling the amount of solid being manipulated. A need therefore remains for methods and devices that can be used to accurately obtain and manipulate small quantities of solids.

### SUMMARY OF THE INVENTION

This invention encompasses methods of manipulating (e.g., obtaining, separating, and moving) and weighing solids, particularly dry powders. Also encompassed by the invention are devices that can be used to accurately weigh and manipulate solids. Specific methods and devices utilize transfer devices, such as, but not limited to, dielectrophoresis-based devices, coring devices, and micromechanical tweezers, to obtain particles of a powder and determine the mass of those particles by measuring the change in the mechanical resonant frequency of the transfer device.

### BRIEF DESCRIPTION OF THE FIGURES

Specific embodiments of the invention can be understood with reference to the attached figures, described below.

FIG. 1 provides a schematic representation of a specific system of the invention, which utilizes a dielectrophoresis-based transfer device

FIG. 2 shows a perspective view of a particular electrode assembly that can be used in the system of FIG. 1

FIG. 3 provides a graph of signal magnitude (dB) as a function of frequency (Hz), from which the resonant frequency of a specific transfer device of the invention can be determined

FIG. 4 provides a graph of negative shift in resonant frequency (Hz) as a function of mass added to a transfer device (micrograms), which indicates agreement between calibration data and the theoretical relationship between a shift in resonant frequency and added mass

FIG. 5 provides another graph of negative shift in resonant frequency (Hz) as a function of mass added to a transfer device (micrograms), which also indicates agreement between experimental data and a calibration curve

FIG. 6 illustrates a device for creating and dispensing a plug of powder that involves inserting a tube completely through a powder bed, lifting, and then ejecting

FIG. 7 illustrates a device for creating and dispensing a plug of powder that involves inserting a tube completely through a powder bed, compressing the plug, lifting, and then ejecting

FIG. 8 illustrates a device for creating and dispensing a plug of powder that involves inserting a tube part way through a powder bed, lifting, and then ejecting

FIG. 9 illustrates a device for creating and dispensing a plug of powder that involves inserting a tube part way through a powder bed with the ejector piston held stationary at a predetermined height relative to the tube, lifting, and then ejecting

FIG. 10 illustrates a method of dispensing and weighing a plug of powder using a coring device and an integrated mass sensor

FIG. 11 illustrates a typical frequency spectrum of the mechanical response of a coring tube that is used to identify its resonant frequency

FIG. 12 illustrates a typical shift in the frequency response of the coring tube when a mass is ejected from the tube

FIG. 13 illustrates a correlation between the measured frequency ratio and the amount of mass dispensed from a coring tube

FIG. 14 illustrates a method of dispensing and weighing a plug of powder using an electrode assembly and an integrated mass sensor

FIG. 15 illustrates a typical frequency spectrum of the mechanical response of an electrode assembly that is used to identify its resonant frequency

FIG. 16 illustrates a correlation between the measured frequency ratio and the amount of mass dispensed from an electrode assembly.

### DETAILED DESCRIPTION OF THE INVENTION

This invention encompasses methods and apparatuses that can be used to accurately pick up, measure, and distribute small quantities (e.g., amounts of less than about 5 mg, 2.5 mg, 1 mg, 75 micrograms, 500 micrograms, 250 micrograms, 100 micrograms, 50 micrograms, 25 micrograms, 10 micrograms, 5 micrograms, or 1 microgram) of solid particles. Particular embodiments of the invention allow the manipulation of controlled amounts of solids, particularly solids in the form of powders. As used herein and unless otherwise indicated, the term “controlled amount” refers to an amount of a compound that is weighed, aliquotted, or otherwise dispensed in a manner that attempts to control the amount of the compound. Preferably, a controlled amount of a compound differs from a target amount by less than about 30, 20, 10, 9, 8, 7, 6, 5, 4, 3, 2, or 1 percent of the target amount. For example, if a target amount of 100 microgram is specified for a particular application, a controlled amount for that application would be a mass that is between about 70 micrograms to about 130 micrograms (30%), or about 80 micrograms to about 120 micrograms (20%), or about 90 micrograms to about 110 micrograms (10%), or about 95 micrograms to about 105 micrograms (5%), or about 99 micrograms to about 101 micrograms (1%).

Embodiments of the invention are particularly suited for the automated or high-throughput manipulation of solids such as, but not limited to, pharmaceuticals, excipients, dietary substances, alternative medicines, nutraceuticals, agrochemicals, sensory compounds, the active components of industrial formulations, and the active components of consumer formulations. Solids manipulated using the methods and devices of the invention can be amorphous, crystalline, or mixtures thereof.

Various embodiments of the invention provide or use a transfer device, which is used to manipulate particles of a given solid, in conjunction with a means of determining the mass or weight of the particles. Examples of transfer devices include, but are not limited to, dielectrophoresis-based devices, coring devices, and micromechanical tweezers.

A first embodiment of the invention encompasses a method of manipulating a solid, which comprises: measuring a first mechanical resonant frequency of a transfer device; creating an electric field on the transfer device that is sufficient to adhere a particle of a solid to the transfer device; adhering one or more particles of the solid to the transfer device by positioning the transfer device sufficiently close to the one or more particles; and measuring a second resonant frequency of the transfer device.

Another embodiment of the invention encompasses a system for manipulating a solid, which comprises: a transfer device comprising a means of creating an electric field; a means of determining a mechanical resonant frequency of the transfer device operatively coupled to the transfer device; and a means of moving the transfer device.

The transfer device used in the methods and devices of the invention need not be based on dielectrophoresis. For example, an embodiment of the invention encompasses a method of manipulating a solid, which comprises: measuring a first mechanical resonant frequency of a tube; inserting the hollow tube into a bed powder to obtain a plug of powder; removing the tube from the bed of powder; and measuring a second resonant frequency of the tube.

Another embodiment of the invention encompasses a system for manipulating a solid, which comprises: a tube having an interior that accommodates a means of ejecting materials from within it; and a means of determining a mechanical resonant frequency of the tube operatively coupled to the tube.

Dielectrophoresis-Based Transfer Devices

In one embodiment of the invention, the transfer device utilizes dielectrophoresis, wherein an electric field is used to attract particles of a solid to the device. Preferably, the electric field is such that the particles will adhere to the transfer device with a force that allows their transfer to, for example, a receptacle (e.g., a vial or a well in a multi-well plate).

Various means exist by which an electric field can be generated. In a particular embodiment of the invention, the transfer device comprises two or more electrodes capable of producing a non-uniform electric field. The electrodes used to generate the electric field can be of any type and can be in any configuration that provides an electric field of sufficient character and intensity. Preferred electrodes are made of a material (e.g., stainless steel) that will not substantially corrode or otherwise react with the solids in which they may be placed in contact. Configurations suitable for use in the invention will be readily apparent to those of ordinary skill in the art. Examples of suitable configurations include, but are not limited to, concentric electrodes, parallel electrodes and interdigitated electrodes. Increasing the number of electrodes or the perimeter of an electrode will tend to increase the amount of solid attached to it, since the electric field is usually greatest at the boundary or edge of an electrode.

Depending on the complex permittivity of the particles and the surrounding medium, the applied voltage can be either DC (constant) or AC (alternating). The strength of the electric field necessary to attract and hold the particles will also depend on their size and nature. However, electrical fields used in typical embodiments of the invention range in strengths of from about 10⁵ V/m to about 10⁸ V/m, from about 10⁶ V/m to about 10⁷ V/m, or from about 2×10⁶ V/m to about 5×10⁶ V/m.

Specific transfer devices and methods of their manufacture and use that may be used in methods and devices of the invention are disclosed in U.S. patent application Ser. No. 09/976,835, filed Oct. 12, 2001, the entirety of which is incorporated herein by reference.

After the weight, or mass, of the particles has optionally been determined, the transfer device can be positioned over a receptacle, or target location, to which the particles are to be transferred. The electric field is then turned off, and the particles are allowed to fall off of the transfer device. In some cases, however, electrostatic or van der Waals forces may prevent all of the particles from detaching from the device. In such cases, a vibration or a sharp inertial knock or jolt can be applied to the transfer device to dislodge the remaining particles. Alternatively, it may be desired to dissolve the particles in a solvent, in which case the tip of the transfer device can be dipped into, or washed with, the solvent.

Coring-Based Transfer Devices

Solids, such as those in the form of a powder, can be manipulated using systems and methods of the invention. For example, solids in the form of fine powders comprising particles having an average size of less than about 150, 100, 50, or 10 microns can be dispensed in controlled amounts as plugs without the use of solvents, high pressures, or temperatures that may affect the form of the solids.

In a particular embodiment of this invention, a controlled amount of a powder is obtained in the form of a plug using a needle, tube, or other hollow device, and optionally compressed into a plug. As used herein and unless otherwise indicated, the term “plug” is used to refer to an agglomeration of a solid or solids. Preferred plugs are not compressed, or are compressed to a degree that is sufficient to provide a plug that can be manipulated to a desired degree but which is insufficient to substantially affect the physical form of the solid (e.g., by incurring a loss of crystallinity or polymorphism). As will be apparent to those of ordinary skill in the art, the particular amount of pressure that can be used to provide such plugs will depend on the particular compound and its form. However, that amount is readily determined using little, if any, routine experimentation. Examples of such pressures include, but are not limited to, less than about 60, 50, 40, 30, 20, or 10 psi. The use of such low pressures typically avoids physical form changes such as loss of crystallinity or conversion to a polymorphic form, which can occur under compression conditions used to make compacted pellets.

In a specific embodiment of the invention, a hollow tube is used to obtain a plug of powder dispersed in a cavity or container. Preferred tubes are made of stiff, lightweight materials that allow the mass or weight of their contents to be determined using methods such as those disclosed herein. First, the mass, or some baseline measurement such as resonance frequency, of the tube is determined. Next, the tube is inserted into a bed of powder to obtain a plug. The tube, which can be of any shape, may be inserted a controlled distance into the powder bed or inserted all the way through the powder bed. As used herein and unless otherwise indicated, the term “controlled distance” refers to a distance that does not differ substantially from a predetermined distance. Preferably, a controlled distance differs from a predetermined distance by less than about 10, 5, or 1 percent of the predetermined distance. For example, if one were to insert a tube 2 mm into a bed of powder, a controlled distance of insertion would preferably be from about 1.9 mm to about 2.1 mm, from 1.95 mm to about 2.05 mm, or from about 1.99 mm to about 2.01 mm.

The mass of the plug is then determined by measuring the mass of the tube, which contains the plug, or making some type of measurement, such as resonance frequency measurement, from which the mass of the plug can be determined (see Section 4.3). The plug may compress, if desired, before or after its mass is determined. In a particular embodiment, the mass of the plug is determined and the tube is reinserted into the powder bed to increase the size of the plug, after which its weight is again determined. In this way, multiple iterations may be used to obtain a controlled amount of powder. Afterwards the tube is positioned over a receptacle (e.g., a tube, vial or a well in a multi-well plate), into which the plug is then ejected using, for example, compressed gas, a liquid in which the solid is soluble, sparingly soluble, or insoluble, vibration of the tube, or mechanical means, such as a piston located within the tube.

Plugs of powder can be lifted from the powder bed by simply removing the tube from the bed if the area of the cavity base (e.g., its diameter) is sufficiently small. For some solids and tube sizes, however, the plug may need to be compacted in order to be manipulated further. The plug can be compacted using a variety of means, such as compressed gas. A specific means uses an actuator-controlled piston or rod located inside the needle to compress the powder into a denser plug. Preferably, the actuator is adjusted so that the pressure used to provide the denser plug is not sufficient to substantially affect the form of the powder (e.g., cause a polymorphic change). Whether or not the plug is compressed, it is typically dispensed by lifting the tube containing the plug from the powder bed, positioning it over a receptacle or receiving plate, and ejecting it using the piston.

Mass Determination

Apart from the ability to transfer small amounts of solids, this invention provides a way of determining the mass of the solid adhered to, or held by, the transfer device. In this way, the invention allows the manipulation of controlled amounts of solids.

Mass determination can be done in a variety of ways that may depend on the precise nature of the transfer device. For example, if the transfer device is a dielectrophoresis-based device, the mass of powder adhered to it can be determined by correlating the static deflection or strain of a simple cantilever beam to the mass of the particles attached to the tip of the transfer device. In preferred embodiments of the invention, however, the mass of the particle(s) adhered to, or contained or held by, the transfer device is determined by measuring the change in the resonant frequency of the transfer device (i.e., the frequency at which the transfer device responds with maximum amplitude). In order to facilitate this determination, the transfer device is preferably stiff and lightweight. Consequently, preferred transfer devices are made from materials that have a high modulus of elasticity and low density. Examples of suitable materials include, but are not limited to: metals, such as, titanium, aluminum; graphite; ceramics; and other such materials known in the art. In addition, the geometry of the device is preferably designed to have a high moment of inertia. Specific transfer devices of the invention are very small, and can be made using microfabrication techniques.

In order to determine the mass of the particle(s) adhered to the transfer device, its resonant frequency is measured before and after their adhesion. This is done using methods known in the art. For example, a motion inducer (e.g., a piezoelectric transducer, solenoid shaker, acoustic speaker, electrostatic comb drives (e.g., fabricated on a silicon chip), or similar means) generates an excitation signal. Specific embodiments of the invention utilize piezoelectric transducers, which can be tailored to allow the transfer of different amounts of energy by appropriate selection of the piezoelectric material and its shape. Different types of excitation signals can be applied to the motion transducer, such as an impulse, step input, or a noise signal, to cause the transfer device to resonate.

The response of the transfer device to the excitation is measured using any of a variety of techniques and devices. Examples include, but are not limited to, capacitance sensors, accelerometers, phase Doppler velocimeters, piezoelectric sensors, and strain gauges. Preferably, the sampling frequency of the sensor is at least two times faster than the resonant frequency of the transfer device to prevent aliasing. If a piezoelectric transducer is used to impart motion to the transfer device, the resonant frequency of the piezoelectric transducer itself can be correlated to the added mass of attached particles. This can be accomplished with an oscillator circuit that takes advantage of the electrical impedance of resonance inherent to piezoelectric transducers. In a particular embodiment, the mechanical response of the transfer device is measured with a laser displacement sensor, which operates by measuring the optical deflection of a laser beam focused on a moving target.

### Exemplification

Certain embodiments of the invention, as well as certain novel and unexpected advantages of the invention, are illustrated by the following non-limiting examples.

### EXAMPLE 1

### Manipulation Using Dielectrophoresis

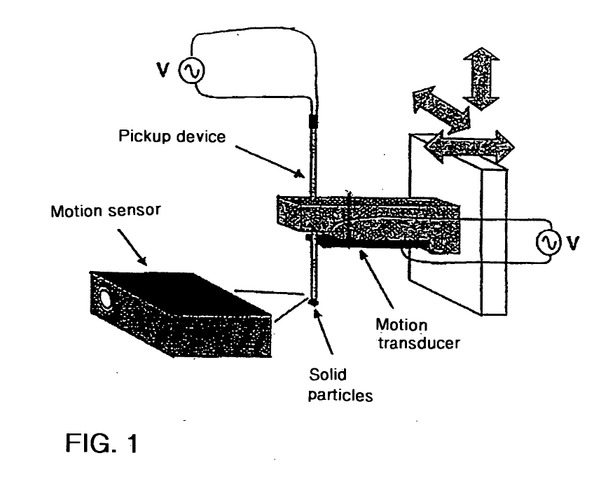

FIG. 1 provides a general illustration of a particular embodiment of the invention, wherein the transfer device, or “pickup device,” is attached to a motion transducer, which in turn is attached to an x-y-z translation stage. A motion sensor is used to measure the response of the transfer device to the signal generated by the motion transducer. In this example, the transfer device is mounted like a vertical cantilever onto a non-conductive fixture that is positioned by a set of computer-controlled, x-y-z motorized linear tables (Intelligent Actuators, Inc., Torrance, Calif.). Only a portion of the electrode assembly extends below the fixture and experiences the applied vibration. In this example, the section is 0.53 mm in diameter, 10 mm in length, and weighs approximately 13 mg.

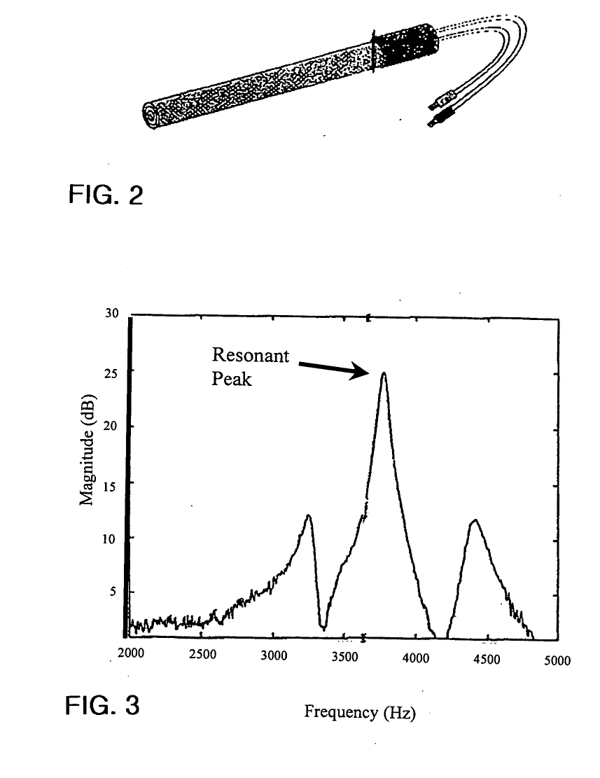

The transfer device used in this example is illustrated in FIG. 2. This example utilizes an electrode assembly purchased from a commercial supplier of metal microelectrodes (FHC Inc., Bowdoinham, Me., Part No. CBHFM75). Using a high voltage power supply (Trek Inc., Medina, N.Y., Model No. 623B) to place the electrodes in an energized state, a non-uniform electric field is created at the tip of the transfer device when positive voltage is applied to an inner electrode and an outer electrode is grounded.

Referring to FIG. 1, the resonant frequency of the transfer device is determined using energy that is transmitted to the device with a thin piezoelectric ceramic material (Piezo Systems, Cambridge, Mass., Part No. T220/A4-203Y). The piezoelectric transducer used in this example is 31.8 mm×6.4 mm×0.51 mm. It is mounted transverse to the transfer device and near the base of the transfer device and in such a way as to minimize the contact area between the transducer and the transfer device. This is done to avoid loading the mass of the transducer to the transfer device during the resonant frequency measurement. The effect of the energy on the transfer device is determined with a laser displacement sensor (Keyence Corp., Woodcliff Lake, N.J., Model No. LC2420A). The motion sensor operates by measuring the optical deflection of a laser beam focused on a moving target. Here, a small piece of specular material (3M Radiant mirror film) is epoxied on the tip of the transfer device to aid in the measurement.

In general, the resonant frequency of a system depends on its mass, stiffness, and damping. Therefore, it is possible to correlate a shift in resonant frequency to change in the system mass. For a simple mass-spring system, the relative change in resonant frequency is directly proportional to the relative change in system mass. Thus, the key to resolving a sub-milligram quantity of mass is to design with minimal mass and maximum resonant frequency.

In this particular embodiment of this invention, the transfer device is calibrated to determine the relationship between a shift in resonant frequency to a mass added to the tip of the transfer device. For the calibration, small pieces of tape with different sub-milligram masses are fixed to the tip of the transfer device. The first resonant frequency of the transfer device is measured before the particles are picked up. To do so, the motion transducer applies small amplitude sinusoidal vibration to the transfer device. The frequency of the vibration sweeps across a narrow frequency range that includes the predicted resonant frequency of the transfer device. The response of the transfer device is measured with a motion sensor. The output signal of the motion sensor is relayed to a dynamic signal analyzer which converts the transient signal into the frequency domain. The analyzer computes the frequency response of the transfer device. In other words, it calculates the magnitude of the ratio of the output signal from the laser sensor to the output signal of the motion transducer across the range of excitation frequencies. From this curve, a peak is observed and the frequency at the center of the peak is taken to be the first resonant frequency of the transfer device.

While the particles are attached to the transfer device, the second resonant frequency of the device is measured again using the same method as used to measure the first resonant frequency. Based on the initial calibration of the system to standard masses, the measured change between the first and second resonant frequencies is correlated to the mass of the attached quantity of particles.

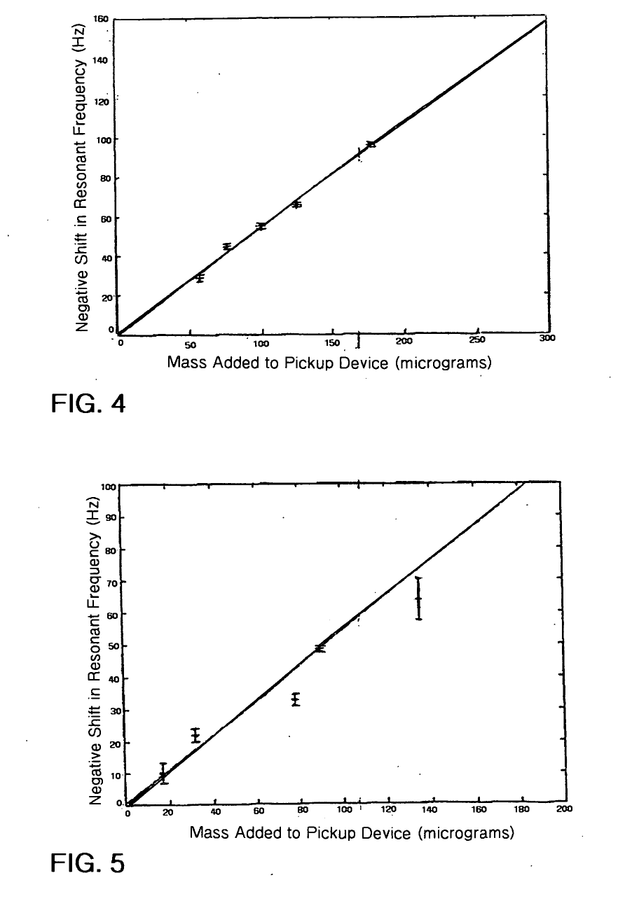

FIG. 3 shows a typical spectrum of the frequency response of the transfer device. The resulting correlation between the change in resonant frequency, (fᵢ−f_{f}), to the attached mass, m, expressed in micrograms was determined to be the following (1):
m=1.854×(fᵢ−f_{f})−0.571 (1)
where fᵢ and f_{f} are the resonant frequencies of the transfer device expressed in Hertz before and after particle adhesion, respectively. The above correlation allows the mass of a quantity of attached particles to be determined by measuring the associated change in resonant frequency. As illustrated in FIGS. 4 and 5, the resonant frequency of the transfer device decreases with increasing mass.

As these figures show, integrating mass measurement with solid particle dispensing in a single apparatus is achieved by measuring correlating shifts in resonant frequency. The mass of the collected particles is calculated by applying the calibration curve to the measured shift in resonant frequency. Agreement between the calibration curve and the data points of weighed quantities of pharmaceutical particles is evidenced by FIG. 5.

### EXAMPLE 2

### Manipulation Using Coring Device

Solids, such as those in the form of a powder, can be manipulated using systems and methods described for the present invention. For example, solids in the form of fine powders comprising particles having an average size of less than about 200, 150, 100, 50, 10, 5, 1, 0.1, or 0.01 micrometers can be dispensed in controlled amounts as plugs without the use of solvents, high pressures, or temperatures that may affect the form of the solids.

In this specific embodiment of the invention, the mechanical resonance frequency of a needle (e.g., a round hollow needle with an inner diameter of about 0.01 mm, 0.1 mm, 0.5 mm, 1 mm, 2 mm, 3 mm, 5 mm or 10 mm) is determined using means such as those described above in Example 1. Next, the needle is inserted into the powder bed to obtain a plug of the powder. The powder bed may, if desired, be uniform as described in U.S. Provisional Application No. 60/423,377 to A. Lemmo, et al., filed Nov. 4, 2002, the entirety of which is incorporated herein. The plug is then optionally compressed, as discussed below. The tube is then removed from the powder bed, and its resonance frequency determined. As discussed elsewhere herein, the change in resonance frequency is used to determine the mass of the plug. If a larger plug is desired, the tube is reinserted into the powder bed, after which it is withdrawn and its resonance frequency again determined. In an alternative embodiment, the mass of the plug is recorded, dispensed into a receptacle (e.g., a tube, vial or a well in a multi-well plate), after which another plug is obtained, its mass recorded and added to that of the previous plug. This process can be repeated as many times as desired to place into the receptacle a controlled amount of the solid.

The plug of powder can be ejected from the needle into a receptacle using a variety of means such as, but not limited to, compressed gas, a liquid in which the solid is soluble, sparingly soluble, or insoluble, vibration of the tube, or mechanical means, such as a piston located within the tube.

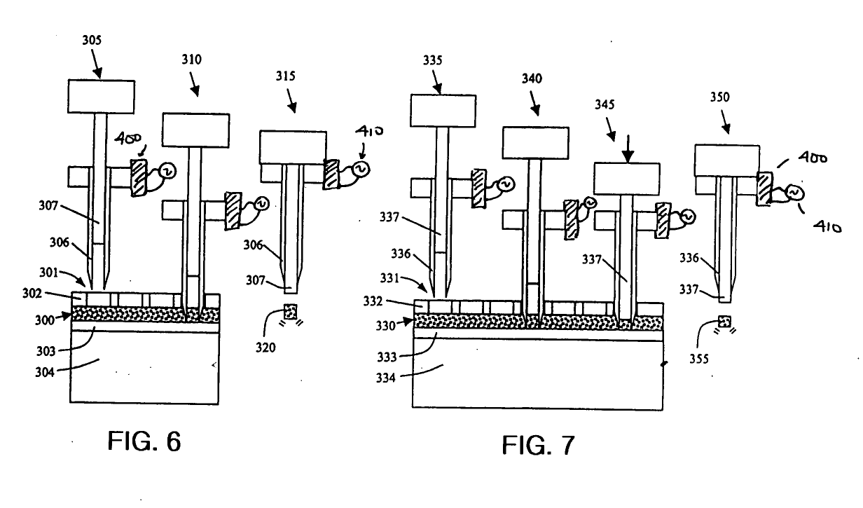

FIG. 6 illustrates a specific method of fabricating a plug from a uniform powder bed. The coring tool 305 comprises a tube 306 and means of ejecting the plug of powder, e.g., a piston 307. The resonance of the tube 306 is first determined using a motion sensor and transducer 400 coupled to it. The piston 307 may be within the tube, as shown in the figure, but is preferably removed from the tube when the measurement is made. Next, the tool 305 is positioned above the hole 301 in grille 302. Next, as shown in view 310, tube 306 is pushed through powder bed 300 until it contacts strike plate 303 on base 304. Next, coring tool 305 is lifted and the resonance of the tube 306, which now contains a plug of powder, is again determined with the piston 307 in the same location it was when the resonance of the tube was first measured. After the mass of the plug is determined from the difference in resonance frequencies, the tool 306 is moved to a target location, and, as shown in view 315, a plug 320 is ejected out of tube 306 via means of ejecting the plug of powder, e.g., a piston 307. This process can be performed without using grille 302, however, for some powders the bed can break apart and portions can stick to the sides of the coring tube, causing large plug mass variation.

Plugs of powder may be lifted from the powder bed by simply removing the tube from the bed if the inner diameter of the tube is sufficiently small. For some solids and tube inner diameters, the plug may need to be compacted in order to adhere to the tube interior sufficiently to be lifted. FIG. 7 illustrates a specific method of fabricating and lifting a compacted plug from a uniform powder bed. The coring tool 335 comprises a tube 336 and means of ejecting the plug of powder, e.g. a piston 337. First, the resonance frequency of the piston 337 is determined using a motion sensor and transducer 400. Next, the coring tool 335 is positioned above hole 331 in grille 332. Next, as shown in view 340, tube 336 is pushed through powder bed 330 until it contacts strike plate 333 on base 334. Next, as shown in view 345, piston 337 is pushed into powder bed 330 with a force sufficient to create a pressure in the range of about 5 to about 5000 psi.

Next, coring tool 335 is lifted and the piston 337 is positioned as it was when the first resonance measurement was made. The resonance of the tube is then determined again using the motion sensor and transducer 400, after which the coring tool 335 moved to a target location, and, as shown in view 350, a compacted plug 355 is ejected out of tube 336 via means of ejecting the plug of powder, e.g., a piston or pin 337. This process can be performed without using grille 332, however for some powders the bed can break apart and portions can stick to the sides of the coring tube, causing large plug mass variation.

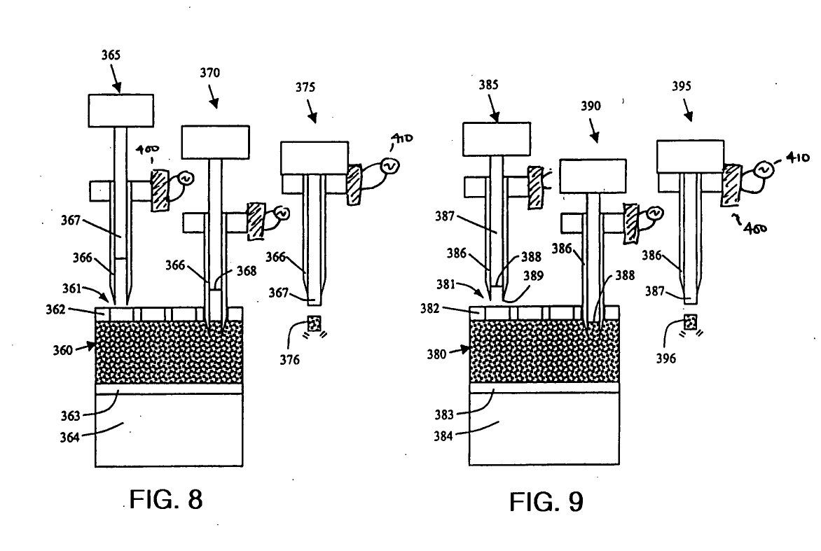

Some powders will have properties that allow a plug with a controlled amount of mass to be produced from a thick bed that is punched multiple times in one place. This is desirable because it increases the number of punches that can be produced from a single packed bed. FIG. 8 illustrates a specific method of fabricating a plug from a uniform powder bed that is taller than the plugs produced. Coring tool 365 comprises a tube 366 and means of ejecting the plug of powder, e.g., a piston or pin 367. The resonance frequency of the tube 366 is determined using a motion sensor and transducer 400. The tool 365 is then positioned above hole 361 in grille 362. Next, as shown in view 370, tube 366 is pushed into powder bed 360 either with a predetermined force, or a predetermined distance. Next, coring tool 365 is lifted and the resonance frequency of the tube 366 is again determined. The tool 365 is then moved to a target location, and, as shown in view 375, a plug 376 is ejected out of tube 366 via means of ejecting the plug of powder, e.g., a piston or pin 367. This process can be performed without using grille 362, however, for some powders the bed can break apart and portions can stick to the sides of the coring tool, causing large plug mass variation.

FIG. 9 illustrates another specific method of fabricating a plug from a uniform powder bed that is taller than the plugs produced. The coring tool 385 comprises a tube 386 and means of ejecting the plug of powder, e.g., a piston 387. The resonance of the tube 386 is first determined using a motion sensor and transducer 400. The tool 385 is then positioned above hole 381 in grille 382. Pin 387 is held stationary to tube 386 so that the distance between piston face 388 and tube edge 389 remains at a fixed specified amount during punching. Next, as shown in view 390, tube 386 is pushed into powder bed 380 either with a predetermined force, or a predetermined distance. Next, coring tool 385 is lifted and the resonance of the tube 386 is again determined. Next, the coring tool 385 is moved to a target location, and, as shown in view 395, a plug 396 is ejected out of tube 386 via means of ejecting the plug of powder, e.g., a piston 387. This process can be performed without using grille 382, however, for some powders the bed can break apart and portions can stick to the sides of the coring tube, causing large plug mass variation.

Commercially available coring tools that are intended for tissue sampling purposes can be used as punching tools for the present invention. An example of a supplier of suitable coring tools for the present invention is Fine Science Tools Inc., 202-277 Mountain Highway, North Vancouver, BC V7J 3P2, Canada, which supplies punching tools with inner tube diameters of 0.35 mm, 0.5 mm, 0.8 mm, 1 mm, 2 mm, 3 mm, and 5 mm. The Fine Science Tools Inc. coring tools include a hardened stainless steel tube and an ejector pin which fits with less than 10 microns of clearance. The outside wall of the tube and ejector pin is chrome plated to reduce surface energy so cored materials are less prone to stick. For creating plugs from very hard powders, a custom tungsten carbide tube and pin assembly is appropriate. A tungsten carbide tube and close fitting pin can be manufactured with sufficient precision, for example, by Bird Precision, One Spruce Street, Waltham Mass., 02454-0569, USA.

### EXAMPLE 3

### Dispensing and Weighing Solids with an Integrated Mass Sensor

Previously described in this invention are the limitations of weighing small amounts (e.g., amounts less than about 5 mg, 2.5 mg, 1 mg, 75 micrograms, 500 micrograms, 250 micrograms, 100 micrograms, 50 micrograms, 25 micrograms, 10 micrograms, 5 micrograms, or 1 microgram) of solid particles with a conventional microbalance (e.g., SC2 Ultra Micro by Sartorius). The current example describes novel methods and apparatuses that can dispense and weigh solids without a conventional microbalance. A transfer device is used to capture and dispense a controlled amount of solid. Transfer devices of the present invention can comprise a coring tool as described in Example 2, micromechanical tweezers, or microelectrodes that attract particles using electric or magnetic fields. A mass sensor is designed to quantify the mass of the captured solids by measuring the mechanical response of the transfer device before and after the solids are captured. Similarly, the mass sensor can quantify the mass of dispensed solids by measuring the mechanical response of the transfer device before and after the solids are dispensed.

In general, the mechanical response of a structure to an applied input force exhibits a unique resonant frequency that is a function of its stiffness and mass. Therefore, the loading or unloading of solids onto a transfer device produces a proportional change in the resonant frequency of the device. As a result, the mass of the solids can be calculated from the measured shift in resonant frequency, assuming that the stiffness of the device does not change and that the solids are securely attached to the device. To increase the sensitivity of this measurement, the transfer device is preferably stiff and lightweight. Specific transfer devices of the invention are very small, and can be made using microfabrication techniques.

To generate a mechanical response from transfer device, a transient force is applied to the transfer device, preferably at a location away from the attached solids. This is done using any of a variety of motion transducers known in the art, such as a piezoelectric actuator, solenoid shaker, impact hammer, acoustic speaker, electrostatic comb drive, or similar means. Different excitation signals can be applied to the motion transducer, such as a sweeping sine wave, impulse, step, or noise inputs to cause the transfer device to resonate.

The mechanical response of the transfer device to the excitation is measured using any of a variety of instruments known in the art, such as a capacitance sensor, accelerometer, phase Doppler velocimeter, piezoelectric sensor, strain gauge, or similar means. Preferably, the sampling frequency of the motion sensor is at least two times faster than the resonant frequency of the transfer device to prevent aliasing. The motion sensor provides an analog voltage signal that corresponds to the movement of the transfer device. Commercial data-acquisition hardware and software is used to record and analyze the transient signal data to obtain a frequency spectrum of the transfer device's mechanical response. The frequency at which the device displays the maximum amplitude of vibration is its resonant frequency. If a piezoelectric transducer is used to impart motion to the transfer device, the resonant frequency of the piezoelectric transducer itself can be correlated to the added mass of attached particles. This can be accomplished with an oscillator circuit that takes advantage of the electrical impedance of resonance inherent to piezoelectric transducers.

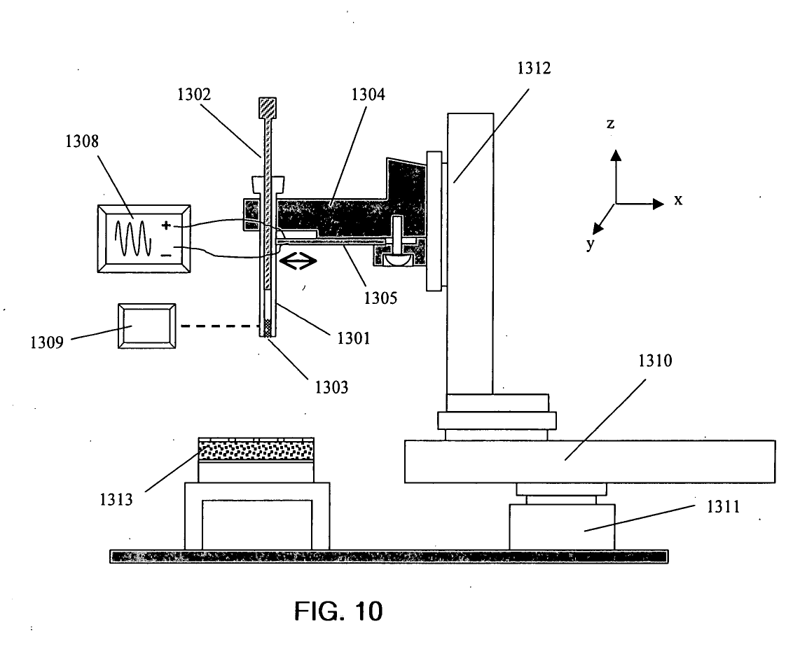

FIG. 10 provides a general illustration of a particular embodiment of the invention, wherein a coring tool is utilized as the transfer device. The coring tool 1301 is a thin-walled stainless steel tube (25.5 standard gauge hypodermic tube, 9 mm in length). The coring tool 1301 contains an internal piston 1302 that is a stainless steel rod (0.34 mm in diameter, 10 mm in length) that slides through the tube to eject a plug 1303 of powder. The coring tool 1301 is securely mounted onto a fixture 1304 that is connected to a set of x—1310, y—1311, and z—1312 linear actuators. The actuators manipulate the coring tool in and out of a powder bed 1313 to extract a plug of powder. Further details of the coring method and apparatus are given in Example 2.

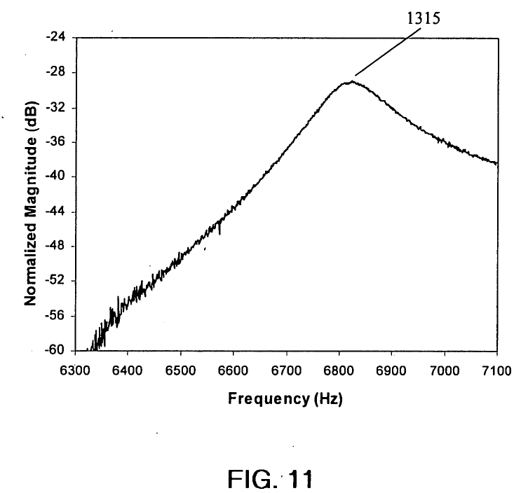

In the embodiment shown in FIG. 10, a piezoelectric ceramic actuator 1305 (Piezo Systems, Cambridge, Mass., Part No. T220/A4-203Y) is affixed between the coring tube 1301 and the fixture 1304. When the internal piston 1302 is withdrawn from the tube 1301, a swept-sine voltage signal, 2 V peak-to-peak between 6.3 kHz and 7.1 kHz, is generated by a function generator 1308 (Model 33120A, Agilent, Palo Alto, Calif.) and applied to the piezoelectric actuator which causes the tube to vibrate. The displacement of the coring tube 1301 in the direction perpendicular to its length is measured with a laser displacement sensor 1309 (e.g., Model LC-2420 by Keyence Corp of America, Woodcliffe, N.J.). For each measurement, 12 consecutive frequency spectra are acquired using commerical data-acquisition hardware (Model #PCI-6052E DAQ board, National Instruments, Austin, Tex.) and customized software (LabVIEW™ Sound and Vibration Toolset, National Instruments, Austin, Tex.). The spectra are averaged linearly with 25% overlap to reduce spectral noise. FIG. 11 shows a typical frequency response of the coring tube when it is empty. The peak 1315 in the spectrum indicates that the resonant frequency of the tube is about 6.8 kHz.

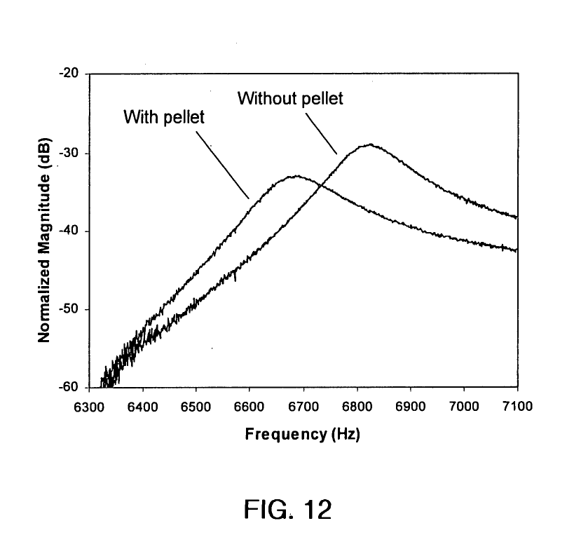

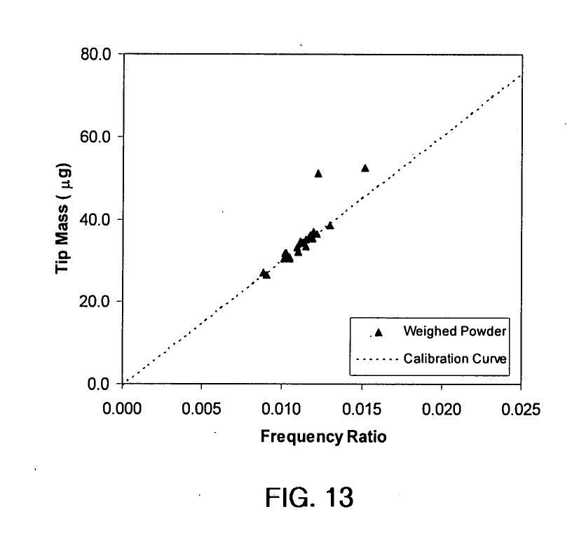

When the transfer device, or in this case the coring tube 1301, captures a small amount of solid or releases a small amount of solid, its resonant frequency will shift from its original value. For example, FIG. 12 shows a 140 Hz increase in the resonant frequency of a coring tube when a solid pellet weighing 62.2 micrograms is dispensed by the coring tube. Therefore, two frequency measurements are made to resolve the mass of the amount added or subtracted from the transfer device. In this embodiment, the relationship between the shift in resonant frequency and the amount of mass dispensed by the coring tube is determined by a calibration procedure. During calibration, the shift in resonant frequency is measured for several different samples whose masses are determined off-line by a conventional microbalance. For the system described in FIG. 10, linear regression by least-squares fitting was performed on the calibration data to determine the following correlation (2):
m=3040×(fₒ−fₘ)/f−0.66 (2)
where m is the dispensed mass expressed in micrograms, and fₘ and fₒ are the resonant frequencies of coring tube expressed in Hertz, before and after the mass is dispensed, respectively. FIG. 13 illustrates strong agreement between the calibration curve and experimental data from weighed quantities of pharmaceutical powder, such as acetaminophen and naproxen, ranging from 26 micrograms to 38 micrograms.

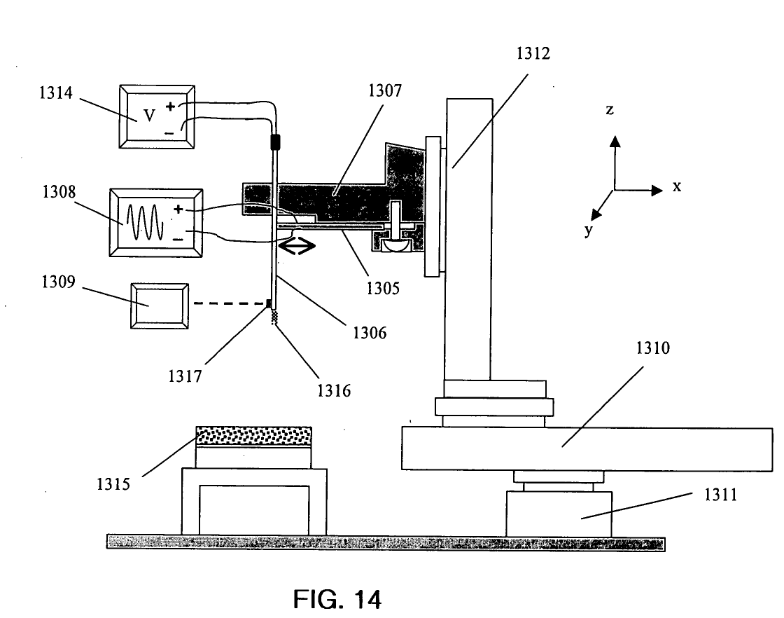

FIG. 14 illustrates another embodiment of the invention, wherein the transfer device is an electrode assembly 1306 that attracts dielectric particles 1316 to its tip surface by imposing a non-uniform electric field near the particles. This phenomenon is scientifically referred to as dielectrophoresis and does not require particles to be charged in order to manipulate them. In dielectrophoresis, when the permittivity of a dielectric particle is greater than that of its surrounding medium, a non-uniform electric field causes uncharged dielectric particles to move towards regions of stronger electric field intensity, regardless of the polarity of the field.

There are various means by which a non-uniform electric field can be generated. Configurations suitable for use in the invention will be readily apparent to those of ordinary skill in the art. Examples of suitable configurations include, but are not limited to, concentric electrodes, parallel electrodes, and interdigitated electrodes. Increasing the number of electrodes or the perimeter of an electrode will tend to increase the amount of solid attached to it, since the electric field is usually greatest at the boundary or edge of an electrode.

Depending on the complex permittivity of the particles and the surrounding medium, the strength of the electric field necessary to attract and hold the particles will also depend on their size and nature. However, electric fields used in typical embodiments of the invention range in strengths from about 10⁵ V/m to about 10⁸ V/m, from about 10⁶ V/m to about 10⁷ V/m, or from about 2×10⁶ V/m to about 5×10⁶ V/m. Specific transfer devices and methods of their manufacture and use that may be used in methods and devices of the invention are disclosed in U.S. patent application Ser. No. 09/976,835, filed Oct. 12, 2001, the entirety of which is incorporated herein by reference.

In the particular embodiment shown in FIG. 14, an assembly 1306 of two concentric metal electrodes (FHC Inc., Bowdoinham, Me., Part No. CBHFM75) is used as the transfer device. A high voltage power supply 1314 (Trek Inc., Medina, N.Y., Model No. 623B) applies positive voltage to the inner electrode while the outer electrode is grounded to create a non-uniform electric field at the tip of the assembly. The electrode assembly is supported by a fixture 1307 which is mounted to a set of x, y, and z linear actuators. The actuators manipulate the electrode assembly toward a powder bed 1315 to extract a controlled amount of dielectric powder 1316.

Referring to FIG. 14, the mechanical response of the transfer device is generated using a thin piezoelectric ceramic actuator 1305 (Piezo Systems, Cambridge, Mass., Part No. T220/A4-203Y) affixed between the base of the electrode assembly and the fixture. A swept-sine voltage signal, 1 V peak-to-peak between 3.6 kHz and 4.0 kHz, is generated by a function generator 1308 (Model 33120A, Agilent, Palo Alto, Calif.) and applied to the piezoelectric actuator to excite the electrode assembly. The displacement on the electrode assembly in the direction perpendicular to its length is measured with a laser displacement sensor 1309 (Keyence Corp., Woodcliff Lake, N.J., Model No. LC2420A). Here, a small piece of specular material 1317 (3M Radiant mirror film) is epoxied on the tip of the transfer device to aid in the measurement.

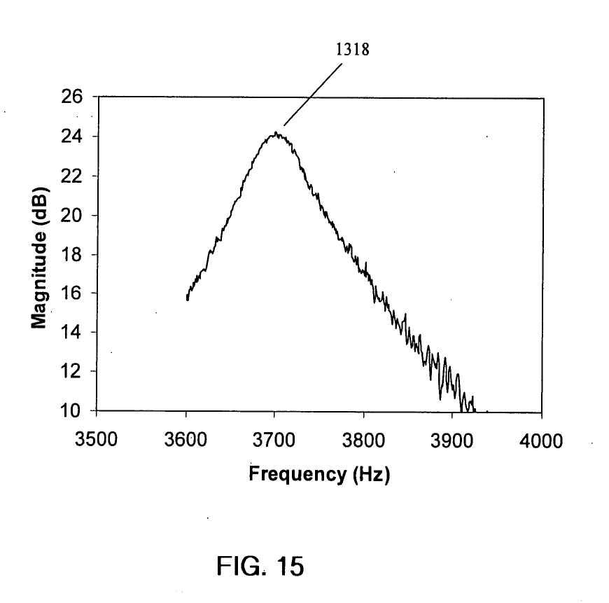

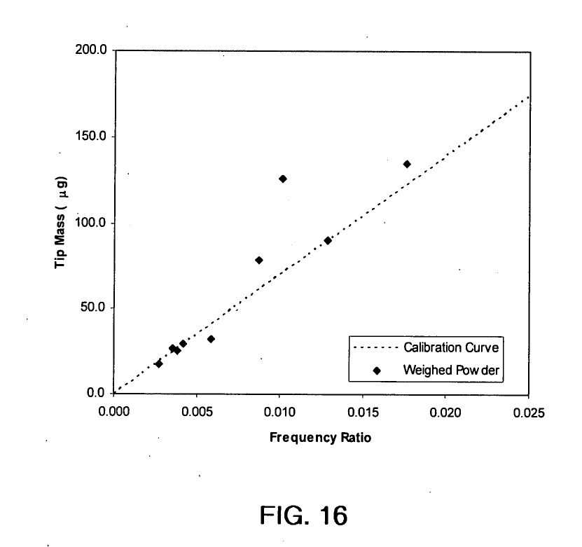

For each measurement, 10 consecutive frequency spectra are acquired using a commercial dynamic signal analyzer (Hewlett Packard, Model 35660A) and averaged linearly with 50% overlap to reduce spectral noise. FIG. 15 shows a typical frequency response of the electrode assembly. The peak 1318 in the spectrum indicates that the resonant frequency of the electrode assembly is about 3.7 kHz. In this embodiment, the relationship between the shift in resonant frequency and the amount of mass captured by the electrode assembly is determined by a calibration procedure. During calibration, the shift in resonant frequency is measured for several different samples whose masses are determined off-line by a conventional microbalance. For the system described in FIG. 14, linear regression by least-squares fitting was performed on the calibration data to determine the following correlation (3):
m=6968×(fₒ−fₘ)/fₒ−0.0586 (3)
where m is the captured mass expressed in micrograms, and fₒ and fₘ are the resonant frequencies of electrode assembly expressed in Hertz, before and after the mass is captured, respectively. FIG. 16 illustrates good agreement between the calibration curve and experimental data from weighed quantities of pharmaceutical powder, such as aspirin and avicel, ranging from 17 micrograms to 90 micrograms.

While the invention has been described with respect to the particular embodiments, it will be apparent to those skilled in the art that various changes and modifications may be made without departing from the spirit and scope of the invention as recited by the appended claims.

1-31. (canceled)

32. A method of manipulating a solid, which comprises:
(a) measuring a first mechanical resonant frequency of a transfer device;
(b) adhering one or more particles of the solid to said transfer device; and
(c) measuring a second resonant frequency of said transfer device.

33. The method of claim 32, further comprising determining the mass of said one or more particles by comparing the first and second resonant frequencies.

34. The method of claim 32, further comprising:
(a) depositing said one or more particles at a target location; or
(b) measuring continuously the resonant frequency of said transfer device to provide a feedback cycle for manipulating said one or more particles of the solid.

35. The method of claim 33, wherein:
(a) the mass of said particles is less than about 1 mg;
(b) the mass of said particles is less than about 500 micrograms; or
(c) the mass of said particles is less than about 100 micrograms.

36. A system for manipulating a solid, which comprises:
(a) a transfer device comprising a means for creating an electric field or gradient that is sufficient to adhere one or more particles of a solid to said transfer device;
(b) a means for determining a mechanical resonant frequency of said transfer device operatively coupled to said transfer device; and
(c) a means for depositing said one or more particles.

37. The system of claim 36, wherein said means for creating an electric field or gradient comprises two or more electrodes coupled to an electrical source.

38. The system of claim 37, wherein said electrodes are:
(a) concentric, parallel, planar, or interdigitated;
(b) concentric;
(c) parallel;
(d) planar; or
(e) interdigitated.

39. The system of claim 36, wherein:
(a) the magnitude of said electric field is from about 10⁵ V/m to about 10⁸ V/m;
(b) the magnitude of said electric field is from about 10⁶ V/m to about 10⁷ V/m;
(c) the magnitude of said electric field is from about 2×10⁶ V/m to about 5 ×10⁶ V/m;
(d) said one or more particles are deposited by removing the electric field;
(e) deposition of said one or more particles is facilitated by the application of mechanical force to the transfer device; or
(f) deposition of said one or more particles is facilitated by removing the electric field coupled with the application of mechanical force to the transfer device.

40. The system of claim 39, wherein said mechanical force is vibration or an abrupt jolt.

41. A method of manipulating a solid, which comprises:
(a) measuring a first mechanical resonant frequency of a hollow tube;
(b) inserting said hollow tube into a powder bed to obtain a plug of powder;
(c) removing the tube from the powder bed; and
(d) measuring a second resonant frequency of the tube.

42. The method of claim 41, wherein said hollow tube has an interior that accommodates a means for ejecting materials from within it.

43. The method of claim 42, wherein:
(a) said means for ejecting materials is a piston, vibration, pressurized gas, or a liquid; or
(b) the material is ejected from the tube after the second resonance frequency is measured.

44. A system for manipulating a solid, which comprises:
(a) a tube having an interior that accommodates a means for ejecting materials from within it; and
(b) a means for determining a mechanical resonant frequency of said tube operatively coupled to said tube.

45. The system of claim 44, wherein the means for determining a mechanical resonant frequency comprises an excitation signal generator and a means for detecting the effect of an excitation signal on the tube.

46. The system of claim 45, wherein:
(a) said excitation signal generator is a piezoelectric transducer, a solenoid shaker, an acoustic speaker, or an electrostatic comb; or
(b) the means for detecting the effect of an excitation signal is a laser displacement sensor, capacitance sensor, accelerometer, phase Doppler velocimeter, piezoelectric sensor, strain gauge, or impedance analyzer.
